(19) United States
(12) Patent Application Publication
(10) Pub. No.: US 2026/0194759 A1
(43) Pub. Date: Jul. 9, 2026

(54) HEAD STRAP AND FACIAL INTERFACE ASSEMBLIES FOR HEAD-MOUNTED DISPLAYS

(71) Applicant: Meta Platforms Technologies, LLC, Menlo Park, CA (US)

(72) Inventor: Luke Fryer, Seattle, WA (US)

(21) Appl. No.: 19/442,021

(22) Filed: Jan. 7, 2026

Related U.S. Application Data
(60) Provisional application No. 63/742,459, filed on Jan. 7, 2025.

(51) Int. Cl. G02B 27/01

(52) U.S. Cl. CPC G02B 27/0176

(57) ABSTRACT

A facial interface assembly for a head-mounted display system. The facial interface assembly can include a flexible facial interface frame element coupled to the frame element and having a perimeter configured to contact a user's face and an attachment mechanism. The attachment mechanism can include a first attachment portion positioned along at least a portion of the perimeter of the flexible facial interface frame element and a second attachment portion positioned along a head strap. The first attachment portion and the second attachment portion are configured to removably couple to one another and to removably couple the facial interface assembly with the head strap.

### CROSS REFERENCE TO RELATED APPLICATION

The present disclosure is related and claims priority under 35 U.S.C. § 119 (e), to U.S. Prov. Appln. No. 63/742,459, entitled AR/VR HEAD STRAP AND FACIAL INTERFACE, to Luke Fryer on Jan. 7, 2025, the contents of which are hereby incorporated by reference in their entirety, for all purposes.

### BACKGROUND

Head-mounted display systems include a display element positioned directly in front of a user's eyes. Artificial reality (“AR”) systems (for example, virtual reality, augmented reality, mixed reality, or hybrid reality systems) often employ head-mounted displays to present images of virtual objects or scenes to the user. The virtual objects or scenes may be part of an entirely virtual environment viewed by the user or may overlay views of a real-world environment surrounding the user.

When worn by the user, head-mounted displays are conventionally supported on the user's head in a variety of ways. For example, a halo-type head-mounted display may include a head strap that extends from the user's forehead and wraps circumferentially around the user's head. A harness-type head-mounted display may include one or more straps or supports that extend over a top of the user's head for additional support. In conventional systems, such head straps are typically coupled to a rigid frame or housing of the head-mounted display.

At least a portion of the weight of the display and associated components is positioned in front of the user's face. This weight may cause discomfort on the user's head, face, and nose, particularly after extended periods of use. In some configurations, tightening a head strap to improve stability may increase pressure between the head-mounted display and the user's face.

Foam or other conformable features are included on some head-mounted displays in an attempt to improve user comfort. However, users have faces and heads with a wide variety of sizes and shapes, making it difficult for such features to provide a comfortable and secure fit across different users. Additionally, conventional head-mounted display frames are generally rigid and do not readily conform to individual facial features, which may result in uneven pressure distribution and reduced comfort.

### SUMMARY

As will be described in greater detail below, the present disclosure describes facial interface assemblies, systems, and related methods, such as for head-mounted display systems, that may include a frame element to physically support a display and a flexible facial interface frame element to conform to the user's facial features.

In some embodiments, the facial interface assembly includes an attachment mechanism comprising a first attachment portion positioned along at least a portion of the perimeter of the flexible facial interface frame element and a second attachment portion positioned along a head strap. The first attachment portion and the second attachment portion may be configured to removably couple to one another to removably couple the facial interface assembly with the head strap.

In some embodiments, the interlocking attachment structure includes complementary engagement surfaces configured to mechanically interlock during sliding engagement and to resist separation in a direction substantially perpendicular to the sliding motion. In some embodiments, the interlocking attachment structure is configured to permit removal of the head strap by reversing the sliding engagement motion between the first attachment portion and the second attachment portion.

Features from any of the embodiments described herein may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of example embodiments and are a part of the specification. Together with the following description, these drawings demonstrate and explain various principles of the instant disclosure.

FIG. 1 is a perspective view of a head-mounted display (“HMD”) system 100 in a partially disassembled state, according to at least one embodiment of the present disclosure.

FIGS. 2A-2B illustrate a top view of an attachment mechanism 200 for removably attaching a facial interface to a head strap, according to at least one embodiment of the present disclosure.

FIGS. 3A and 3B illustrate side views of an HMD system worn by a user, according to at least one embodiment of the present disclosure.

FIGS. 4A-4B are views of a frame body of a facial interface assembly as worn by a user, according to at least one embodiment of the present disclosure.

FIG. 5 illustrates a view of the facial interface assembly in a condition in which the attachment mechanism is not fully engaged, according to at least one embodiment of the present disclosure.

FIG. 6 illustrates a view of the facial interface assembly after the attachment mechanism has been engaged to couple the head strap to a perimeter of the facial interface assembly, according to at least one embodiment of the present disclosure.

FIG. 7 is a flow diagram illustrating a method 700 of engaging an attachment mechanism in a head-mounted display system, according to at least one embodiment of the present disclosure.

FIGS. 8A and 8B show a VR system, according to at least one embodiment of the present disclosure.

FIG. 9 illustrates a computing system and an optional housing, each of which show components that can be included in an AR system and/or VR system, according to at least one embodiment of the present disclosure.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the instant disclosure covers all modifications, equivalents, and alternatives falling within the scope of the appended claims.

### DETAILED DESCRIPTION OF EXAMPLE EMBODIMENTS

The present disclosure is generally directed to facial interface assemblies and related systems and methods, such as for head-mounted displays (for example, artificial reality displays). As will be explained in greater detail below, embodiments of the instant disclosure may relate to a head strap and facial interface for a head-mounted display (HMD). Existing head straps and their associated tightening mechanisms may be uncomfortable since tightening the head strap may force the HMD's facial interface against a user's face. The disclosed system, in contrast, may include a head strap directly connected (such as via an interlocking “French cleat” structure and magnets) to a flexible facial interface. Connecting the head strap directly to the facial interface may be more comfortable than traditional HMD headsets where the head strap is connected to the HMD frame structure.

In one example, the disclosed system may include a flexible facial interface extending from an HMD and a head strap connected to the outer surface of the flexible facial interface. In some examples, the head strap may be removable and/or directly attached to the flexible facial interface. In addition, tightening the head strap may secure the HMD and the flexible facial interface to the user's head and face, ensuring even pressure and a full-contact fit around the perimeter of the flexible interface. In some examples, the head strap may attach directly to the outer surface of the flexible facial interface through an interlocking structure (for example, French cleat). The cleat may include magnets (for example, Neodymium magnets) embedded within the frame of the cleat. In some examples, both the head strap and the flexible facial interface may include a cleat attached to their respective structures. The cleats may be designed to interlock, allowing the cleat on the head strap to slide into the cleat on the flexible facial interface. Once engaged, the embedded magnets within each cleat may create a secure tension hold, ensuring the cleats are firmly connected. In other examples, the HMD system may include rotatable arms on a left side and a right side of the HMD, where each rotatable arm is positioned proximal to the flexible facial interface.

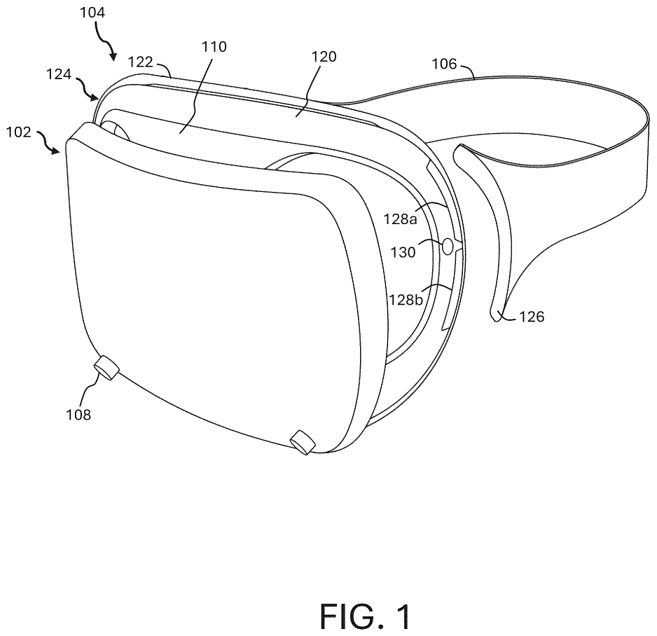

The following will provide, with reference to FIGS. 1-9, detailed descriptions of various embodiments of facial interface assemblies for head-mounted display systems.

FIG. 1 is a perspective view of a head-mounted display (“HMD”) system 100 in a partially disassembled state. The HMD system 100 may include a display 102, a facial interface assembly 104 for supporting the display 102 and for resting the HMD system 100 against a user's face, and a head strap 106 for securing the HMD system 100 on the user's head. The head strap 106 may extend around a rear portion of the user's head and, in some examples, over a top portion of the user's head.

The display 102 may include an electronic display for an artificial reality (for example, virtual reality, augmented reality, mixed reality, hybrid reality, etc.) system, for example. The display 102 may include one or more display elements (for example, LCD display elements, image combiners, hot mirrors, LED displays, OLED displays, etc.), a graphics processing unit for rendering an image on the display element, one or more image sensors 108 (for example, cameras), one or more optical lenses, an eye-tracking element, a GPS sensor, one or more motion sensors (for example, accelerometers, proximity sensors, light sources (for example, infrared light sources)), a power source, a wireless or wired communication component, etc. The power source and/or wired communication component, if present, may include an electrical cable, which may extend from the display 102 to a computer, controller, battery pack, electrical outlet, mobile device, etc.

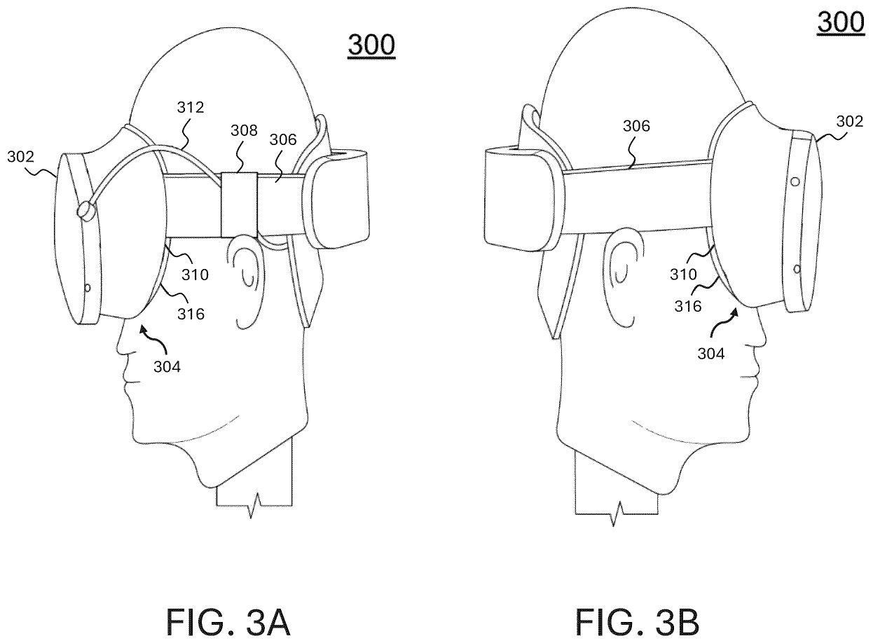

In some embodiments, the display 102 may be removable and replaceable relative to the facial interface assembly 104, as shown in FIG. 3. For example, the facial interface assembly 104 may be configured to interchangeably support different displays 102, or to remove and replace the display 102 for cleaning the display 102 and/or the facial interface assembly 104, for electrically charging the display 102, or for other maintenance to the display 102.

The facial interface assembly 104 may include a frame element 110 shaped and configured to physically support the display 102 in front of a user's eyes when the facial interface assembly 104 is worn by the user. Accordingly, the frame element 110 may have a shape that is complementary to a shape of the display 102. The frame element 110 may include one or more engagement elements, such as magnets, notches, protrusions, latches, clips, or combinations thereof, configured to removably couple the display 102 to the frame element 110. In some examples, an electrical connector may be disposed on the frame element 110 and configured to electrically connect the display 102 to an electrical cable or internal circuitry. Corresponding engagement elements and/or electrical connectors may be included on the display 102. In other embodiments, the display 102 may be removably coupled to the frame element 110 without dedicated engagement elements, for example by a friction fit between the display 102 and the frame element 110.

The facial interface assembly 104 may also include a flexible facial interface frame element 120 that is configured to flex to conform to the user's facial features when the HMD system 100 is worn by the user. In some embodiments, the flexible facial interface frame element 120 can include an outer periphery that is independently movable relative to an outer periphery of the frame element. In some examples, an extensible material may be disposed between the flexible facial interface frame element and the frame element. Such facial interface assemblies may enable a comfortable and adaptable fit for a variety of different face shapes and sizes.

In some embodiments, a facial ribbon 122 may be disposed on an inner surface of the flexible facial interface frame element 120, facing toward the user's face when the HMD system 100 is worn. The facial ribbon 122 may be configured to contact the user's face and provide a comfortable interface therewith. The facial ribbon 122 may include, for example, a closed-cell foam, an open-cell foam, an elastomeric material, or combinations thereof, and may optionally be covered by a fabric or textile layer. A frame body 124 of the facial interface assembly 104 may include the frame element 110 and the flexible facial interface frame element 120.

At least a portion of the flexible facial interface frame element 120, such as an outer periphery or a nasal bridge portion, may be flexible in a forward and backward direction relative to a user wearing the HMD system 100, thereby enabling the flexible facial interface frame element 120 to flex and conform to the user's facial size and shape during use. As used herein, the term “flexible” may be used in a relative sense. For example, the flexible facial interface frame element 120 may be relatively more flexible in the forward and backward direction than the frame element 110, even though both elements may exhibit some degree of flexibility.

The relative flexibility of the flexible facial interface frame element 120 may be achieved through material selection, structural configuration, or a combination thereof. For example, a thickness of the flexible facial interface frame element 120 in the forward and backward direction A may be sufficiently small to enable flexing in response to relatively small forces, such as forces applied by the head strap 106 when securing the HMD system 100 to the user's head. Due to this flexibility, the flexible facial interface frame element 120 may be customizable and adaptable to a variety of different face shapes, facial features, and sizes. In some embodiments, the flexible facial interface frame element 120 and the frame element 110 may be formed from polymer materials, metal materials, fiber-matrix composite materials, or combinations thereof. In one non-limiting example, the frame body 124, including the frame element 110 and the flexible facial interface frame element 120, may be formed from a thermoplastic polymer material, such as nylon.

According to embodiments, an interlocking attachment structure 128 (collectively referring to interlocking attachment structure 128a and interlocking attachment structure 128b) and magnetic retention element 130 are disposed on the frame element 110 such as to connect the facial interface assembly 104 with the strap 106. The head-mounted display system 100 may include an interlocking attachment structure 128 configured to removably couple the head strap 106 to the facial interface assembly 104. The interlocking attachment structure 128 may be positioned at or adjacent to an edge of the frame element 110, including along a perimeter region of the facial interface assembly 104. In some embodiments, the interlocking attachment structure 128 may extend along at least a portion of the perimeter of the facial ribbon 122.

In some embodiments, the interlocking attachment structure 128 is formed as a frame-edge engagement feature located at a perimeter of the facial ribbon 122 disposed along the facial interface assembly 104. For example, the interlocking attachment structure 128 may include a French cleat configuration comprising complementary angled and/or beveled engagement surfaces configured to mechanically interlock when engaged to a corresponding angled and/or beveled surface.

According to some embodiments, the interlocking attachment structure 128 may include one or more engagement portions formed on the frame element 110 (for example, interlocking attachment structure 128a and interlocking attachment structure 128b, as shown in FIG. 1) and configured to engage a complementary engagement portion formed on the head strap 106. In some embodiments, the interlocking attachment structure 128 includes a first cleat portion formed at a frame edge of the facial interface assembly and a second cleat portion formed on the head strap 106, the first and second cleat portions being configured to interlock during a sliding engagement.

The interlocking attachment structure 128 may be configured to permit the head strap 106 to be attached by a sliding motion. For example, the head strap 106 may be advanced in a direction from a front portion of the facial interface assembly 104 toward a rear portion of the facial interface assembly 104, such that complementary portions of the interlocking attachment structure 128 engage as the head strap 106 is slid into position. Once engaged, the interlocking attachment structure 128 may resist separation in directions substantially perpendicular to the sliding direction, thereby providing a secure mechanical connection.

In some examples, the term “substantially” in reference to a given parameter, property, or condition may refer to a degree that one skilled in the art would understand that the given parameter, property, or condition is met with a small degree of variance, such as within acceptable manufacturing tolerances. For example, a parameter that is substantially met may be at least about 90% met, at least about 95% met, or at least about 99% met.

One or more magnetic retention elements 130 may be associated with the interlocking attachment structure 128. In some embodiments, the magnetic retention element 130 is molded into the frame element 110, such that the magnetic retention element 130 is embedded within the material of the frame element 110 and not exposed on an outer surface thereof (for example, an exterior surface of the frame element 110). In other embodiments, the magnetic retention element 130 may be overmolded, insert molded, or otherwise fixed within the frame element 110.

The magnetic retention element 130 may be configured to magnetically attract a corresponding magnetic or magnetically responsive element associated with a strap attachment portion 126 of the head strap 106. The magnetically responsive element can be disposed on the strap attachment portion 126 or molded into the strap attachment portion 126. During attachment, as the head strap 106 is slid from the front toward the back of the facial interface assembly 104, the magnetic retention element 130 may generate a magnetic force that draws the head strap 106 toward the interlocking attachment structure 128, thereby assisting alignment and engagement of the interlocking attachment structure 128.

When the head strap 106 is fully engaged with the interlocking attachment structure 128, the magnetic retention element 130 may cooperate with the interlocking attachment structure 128 to maintain the head strap 106 in a retained position. In such embodiments, the magnetic retention element 130 may provide an initial retention force, while the interlocking attachment structure 128 bears tensile loads applied by the head strap 106 during use of the head-mounted display system 100.

In operation, tension applied to the head strap 106 may urge the interlocking attachment structure 128 into increased mechanical engagement, thereby enhancing retention as strap tension increases. This configuration may allow the head strap 106 to be securely retained during use while remaining removable by reversing the sliding motion in a direction from the rear toward the front of the facial interface assembly 104.

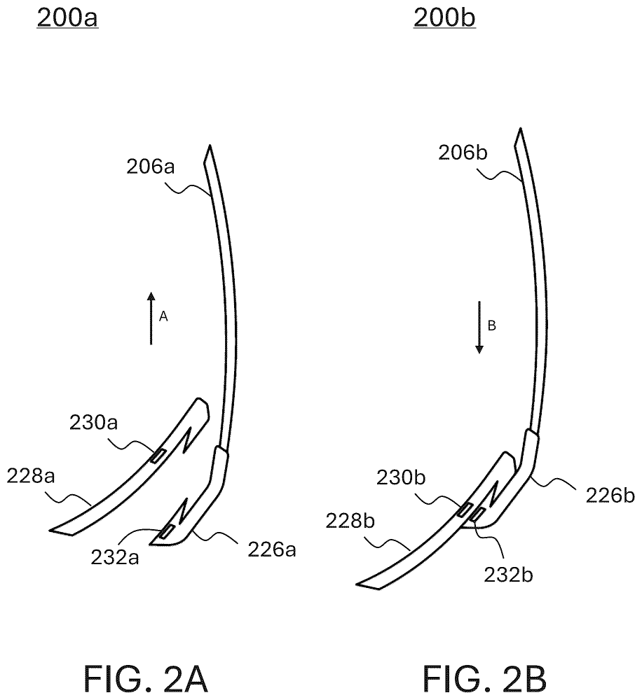

FIGS. 2A-2B illustrate a top view of an attachment mechanism 200 for removably attaching a facial interface (for example, facial interface 104) to a head strap (for example, head strap 106). The attachment mechanism 200 may be implemented on a head-mounted display, headset, eyewear device, or similar wearable system. FIG. 2A depicts an attached configuration of the attachment mechanism 200a, in which the facial interface and the head strap are coupled to one another. FIG. 2B depicts a detached or decoupled configuration of the attachment mechanism 200b, in which the facial interface and the head strap are separated prior to engagement or after removal.

As shown in FIGS. 2A and 2B, a head strap portion 206a, 206b extends around a head when worn by a user and is configured to secure the head-mounted display system to the user's head. The head strap portion 206a, 206b may be flexible, semi-rigid, or rigid and may be formed from polymeric, elastomeric, textile, composite, or combinations thereof.

The attachment mechanism 200 includes a strap attachment portion 226a, 226b coupled to or integrally formed with the head strap portion 206a, 206b. The strap attachment portion 226a, 226b is configured to mechanically engage a corresponding interface attachment portion 228a, 228b of a facial interface assembly (for example, facial interface assembly 104).

According to embodiments, the facial interface assembly includes the interface attachment portion 228a, 228b positioned along an edge or perimeter region of the facial interface, such as along a perimeter of frame element 110, facial ribbon 122, or flexible facial interface frame element 120. The interface attachment portion 228a, 228b may be formed as a frame-edge engagement feature and may extend along at least a portion of the perimeter of the facial interface.

Strap attachment portion 226a, 226b and the interface attachment portion 228a, 228b together form an interlocking attachment structure configured to engage via a sliding motion. In some embodiments, the interlocking attachment structure comprises complementary angled or hooked engagement surfaces, such as a French-cleat-type configuration, that are configured to mechanically interlock when engaged.

As shown in FIG. 2A, during attachment, the strap attachment portion 226a is slid relative to the interface attachment portion 228a, for example in a direction A from a front region of the facial interface toward a rear region of the facial interface. As the sliding motion proceeds, the complementary engagement surfaces interlock, resulting in the attached configuration 200a.

As shown in FIG. 2B, in the detached configuration 200b, the strap attachment portion 226b is separated from the interface attachment portion 228b prior to engagement or after disengagement. Disengagement may be accomplished by reversing the sliding motion, for example, by sliding the strap attachment portion 226b in a direction opposite the attachment direction. For example, disengagement can be accomplished by sliding the strap attachment portion 226b in a direction B from a rear region of the facial interface toward a front region of the facial interface.

According to embodiments, one or more magnetic retention elements 230a, 230b may be associated with the attachment mechanism 200. In the illustrated embodiment, the magnetic retention elements 230a, 230b are disposed on or within the interface attachment portion 228a, 228b and are configured to magnetically attract a corresponding magnetic or magnetically responsive element on the strap attachment portion 226a, 226b. In some embodiments, the magnetic retention elements 230a, 230b are embedded, insert-molded, or overmolded within the facial interface structure such that they are not exposed on an exterior surface.

The magnetic retention elements 230a, 230b may assist in guiding and aligning the strap attachment portion 226a, 226b during attachment and may provide an initial retention force that holds the components together once engaged. The magnetic retention elements 230a, 230b may supplement, but do not replace, the mechanical load-bearing function of the interlocking attachment structure.

According to embodiments, one or more first magnetic elements 230a, 230b may be associated with the attachment mechanism 200. The first magnetic elements 230a, 230b are disposed on or within the interface attachment portion 228a, 228b of the facial interface assembly. The first magnetic elements 230a, 230b may be embedded, insert-molded, overmolded, or otherwise fixed within the facial interface structure, and in some embodiments may not be exposed on an exterior surface thereof.

According to embodiments, one or more second magnetic elements 232a, 232b may be associated with the strap attachment portion 226a, 226b of the head strap 206a, 206b. The second magnetic elements 232a, 232b are configured to magnetically connect to the corresponding first magnetic elements 230a, 230b when the strap attachment portion 226a, 226b is brought into proximity with the interface attachment portion 228a, 228b.

The first magnetic elements 230a, 230b and the second magnetic elements 232a, 232b may be arranged with complementary magnetic polarities such that magnetic attraction occurs during attachment. The magnetic connection may assist in guiding and aligning the strap attachment portion 226a, 226b relative to the interface attachment portion 228a, 228b during a sliding engagement of the interlocking attachment structure. In some implementations, the first magnetic elements 230a, 230b and the second magnetic elements 232a, 232b are a neodymium magnets model in a frame of a headset.

When the attachment mechanism 200 is in the attached configuration, the magnetic connection between the first magnetic elements 230a, 230b and the second magnetic elements 232a, 232b may provide an additional retention force that supplements the mechanical coupling provided by the interlocking attachment structure. In some embodiments, the interlocking attachment structure may bear primary tensile loads applied by the head strap 206a, 206b during use, while the magnetic elements may resist unintended disengagement and maintain positional alignment.

In operation, tension applied to the head strap portion 206a, 206b may urge the strap attachment portion 226a, 226b further into mechanical engagement with the interface attachment portion 228a, 228b, while the magnetic attraction between the first and second magnetic elements maintains contact and stability of the attachment mechanism 200. Disengagement may be accomplished by reversing the sliding motion, overcoming the magnetic attraction and disengaging the interlocking attachment structure.

FIGS. 3A and 3B illustrate side views of a head-mounted display (“HMD”) system 300 worn by a user. FIG. 3A illustrates a first side view of the HMD system 300, and FIG. 3B illustrates a second side view of the HMD system 300.

As shown in FIGS. 3A and 3B, the HMD system 300 includes a display 302 positioned in front of the user's eyes, a facial interface assembly 304 configured to interface with the user's face, and a head strap 306 configured to secure the HMD system 300 to the user's head. The facial interface assembly 304 may include a flexible facial interface frame 310 and a facial ribbon 316 configured to conform to the user's facial features, as described herein.

The head strap 306 may extend rearwardly from the facial interface assembly 304 and around a rear portion of the user's head. In some embodiments, the head strap 306 is removably coupled directly to a perimeter of a frame of the facial interface assembly 304, such as along a perimeter region of the flexible facial interface frame 310 or facial ribbon 316. The head strap 306 may be coupled to the facial interface assembly 304 via an interlocking attachment structure positioned at or adjacent to the perimeter of the facial interface assembly 304.

The interlocking attachment structure may include complementary engagement features configured to mechanically interlock during a sliding engagement. In some implementations, this can include a French-cleat-type configuration used to implement the interlocking attachment structure. One or more magnetic retention elements may be associated with the interlocking attachment structure to assist alignment during attachment and to provide supplemental retention once engaged.

In some embodiments, the head strap 306 includes one or more adjustable portions 308 configured to allow a user to adjust a fit or tension of the head strap 306. The adjustable portions 308 may include mechanical adjustment mechanisms such as buckles, sliders, ratcheting mechanisms, hook-and-loop fasteners, or combinations thereof. When tensioned, the head strap 306 may apply a force that urges the facial interface assembly 304 toward the user's head and face.

In operation, tension applied to the head strap 306 may snug the facial interface assembly 304 against the user's head and face, causing the flexible facial interface frame and facial ribbon to conform to the user's facial features. This configuration may provide even pressure distribution and a full-contact fit around both the user's head and the perimeter of the facial interface assembly 304, thereby enhancing comfort and stability during use.

As shown in FIG. 3A, the HMD system 300 may further include a cable 312. The cable 312 may provide power, data communication, or both between the display 302 and an external device. In some embodiments, the cable 312 is routed along or integrated within the facial interface assembly 304 or the display 302 (not depicted). In some embodiments, the strap includes an adjustable component 308 configured to retain the cable 312 along the HMD system 300. The battery may be positioned on or within a rear portion of the head strap 306, such as at a back of the user's head, to counterbalance the weight of the display 302. In other embodiments, the battery may be positioned at other locations along the head strap or associated with the HMD 300.

According to embodiments, the HMD System 300 can include integrated audio functionality. Audio may be implemented through conductive fibers embedded within the head strap 306 materials, for example, with bonded audio drivers incorporated into the head straps 306. Audio output may additionally or alternatively be provided by audio drivers integrated directly into the HMD 300 housing and/or via Bluetooth audio connectivity to external Bluetooth-enabled earbuds or headphones.

FIG. 3B illustrates the opposing side view of the HMD system 300. The components shown in FIG. 3B may be substantially similar to those shown in FIG. 3A, including the display 302, facial interface assembly 304, head strap 306, interlocking attachment structure, etc. In the illustrated view of FIG. 3B, cable 312, for example, is not visible due to its placement on the opposing side of the HMD system 300.

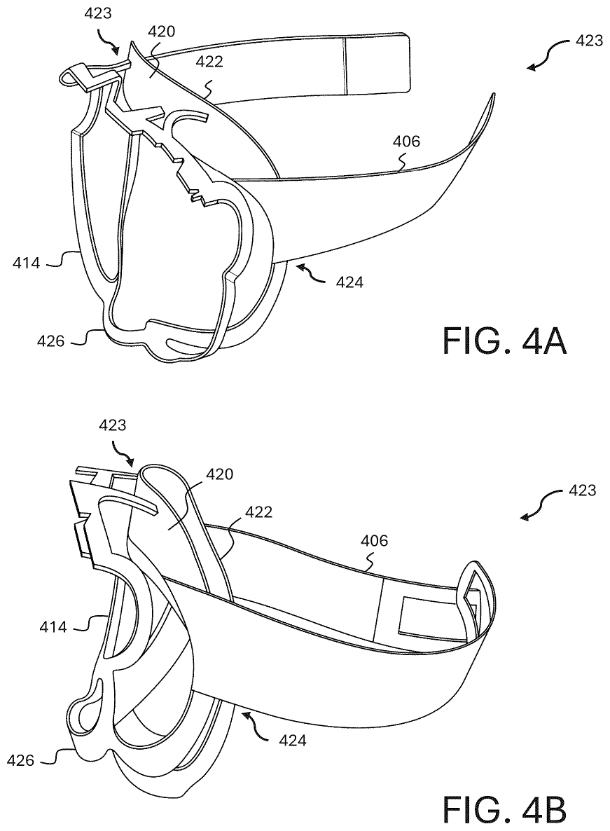

FIGS. 4A-4B are views of a frame body 423 of a facial interface assembly as worn by a user, according to at least one embodiment of the present disclosure. Specifically, FIG. 4A is a perspective view of the frame body 423 and FIG. 4B is a side view of the frame body 423. The facial interface assembly may be the same as or similar to the facial interface assemblies 104 and 304 described above with reference to FIGS. 1-3.

For example, the facial interface assembly may include a frame element 414, a flexible facial interface frame element 420, and a facial ribbon 422. The facial ribbon 422 may be disposed on an inner surface of the flexible facial interface frame element 420, facing toward the user's face when worn. An interlocking attachment structure may be positioned at an outer periphery 424 of the flexible facial interface frame element 420 and may be configured to couple a head strap 406 to the facial interface assembly. The frame element 414 may be configured to couple the flexible facial interface frame element 420 to a headset or the like. A nasal bridge portion 426 of the flexible facial interface frame element 420 may be positioned to be over a nasal bridge of the user's nose when worn.

As shown in FIG. 4, the nasal bridge portion 426 of the flexible facial interface frame element 420 may be configured to flex to conform to the user's nose in response to tension transmitted through the interlocking attachment structure from the head strap 406. Different users may have different nose shapes and sizes, and the flexing of the nasal bridge portion 426 may accommodate such differences to provide a comfortable and secure fit. For example, the nasal bridge portion 426 may be configured to flex forward and backward to accommodate user noses with respectively protruding or relatively flat nasal bridges. In some embodiments, the nasal bridge portion 426 may additionally be configured to flex inward and outward to accommodate relatively narrow or wide user noses. Such movement of the nasal bridge portion 426 may be substantially independent from the frame element 414. Thus, movement of the nasal bridge portion 426 to conform to a user's facial features (for example, the user's nose) may not result in substantial movement of the frame element 414.

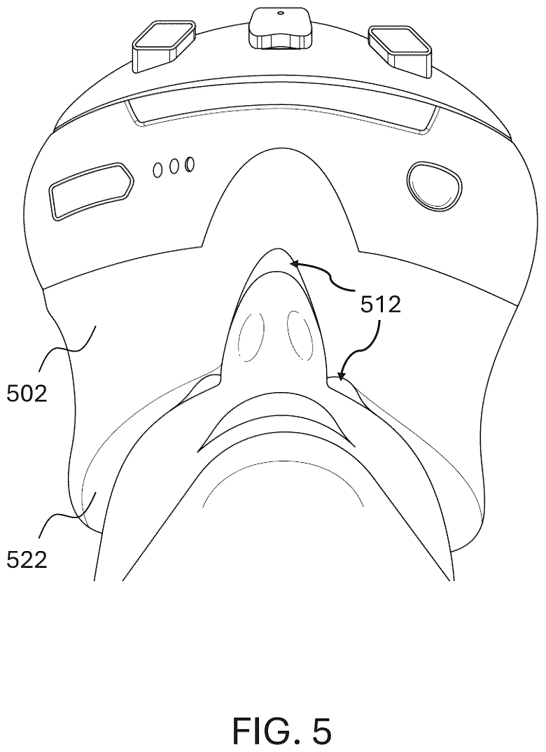

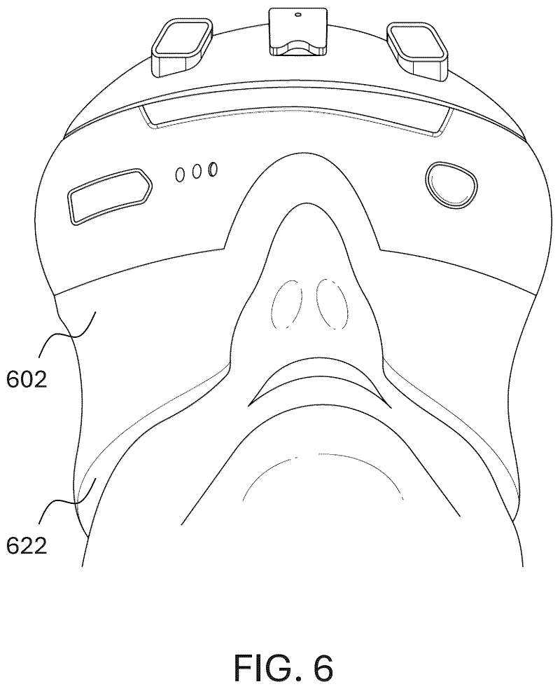

FIGS. 5 and 6 illustrate comparative views of an HMD including a facial interface attached to a strap using an attachment mechanism (for example, attachment mechanism 200) as worn by a user, according to one or more aspects of embodiments. FIGS. 5 and 6 show, for example, a difference in fit before and after engagement of the attachment mechanism coupling a head strap to a facial interface assembly, according to at least one embodiment of the present disclosure.

FIG. 5 illustrates a view of the facial interface assembly 502 in a condition in which the attachment mechanism is not fully engaged (for example, attachment mechanism 200b). In this configuration, the head strap may be detached, partially attached, or not tensioned through the attachment mechanism. As shown, the facial ribbon 522 of the facial interface assembly does not fully conform to the contours of the user's face. One or more gaps 512 may be present between the facial ribbon and portions of the user's face, including at or around a nasal bridge region of the user.

In the configuration shown in FIG. 5, the flexible facial interface frame element may be in a relatively uncompressed or relaxed state due to the absence of tension transmitted through the attachment mechanism. As a result, the facial interface assembly 502 may not achieve full contact around the perimeter of the user's face.

FIG. 6 illustrates a view of the facial interface assembly 602 after the attachment mechanism has been engaged to couple the head strap to a perimeter of the facial interface assembly 602. In this configuration, tension generated by the head strap is transmitted through the attachment mechanism to the flexible facial interface frame element.

As shown in FIG. 6, the tension produced through the attachment mechanism urges the facial interface assembly 602 toward the user's head and face, causing the flexible facial interface frame element and facial ribbon 622 to deform and conform to the user's facial contours. In particular, the facial ribbon 622 conforms closely around the nasal bridge region and adjacent facial areas, substantially eliminating gaps present in the configuration shown in FIG. 5.

According to embodiments, engagement of the attachment mechanism results in a uniform pressure distribution around the perimeter of the facial interface assembly 602. The uniform pressure distribution may provide a snug, full-contact fit between the facial ribbon 622 and the user's face while reducing localized pressure points.

The comparison between FIGS. 5 and 6 illustrates that the conforming fit of the facial interface assembly 502 and 602 is produced by tension transmitted through the attachment mechanism. By coupling the head strap directly to the perimeter of the facial interface assembly, the attachment mechanism enables strap-generated tension to be applied in a controlled manner to the flexible facial interface frame element, thereby improving sealing, comfort, and stability during use.

Although FIGS. 5 and 6 illustrate one example of facial interface deformation and fit improvement, it will be understood that the degree and location of deformation may vary depending on user facial geometry, strap tension, material properties of the facial interface assembly, and configuration of the attachment mechanism, without departing from the scope of the present disclosure.

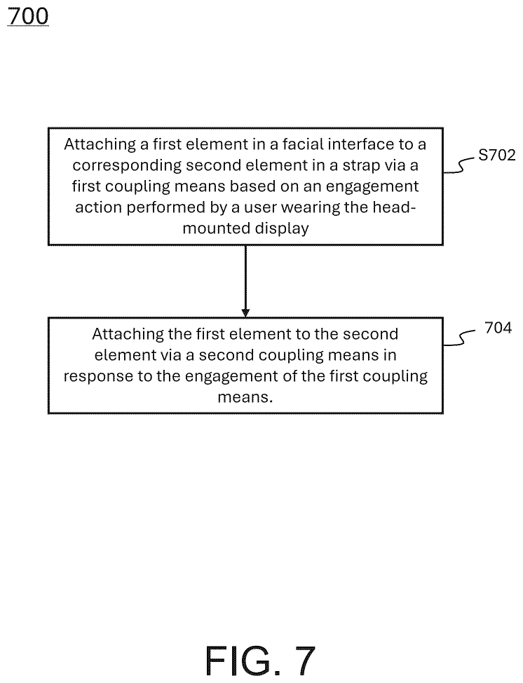

FIG. 7 is a flow diagram illustrating a method 700 of engaging an attachment mechanism in a head-mounted display system, according to at least one embodiment of the present disclosure.

At operation 702, method 700 includes attaching a first element in a facial interface to a corresponding second element in a strap via a first coupling means based on an engagement action performed by a user wearing the head-mounted display.

At operation 704, method 700 includes attaching the first element to the second element via a second coupling means in response to the engagement of the first coupling means.

According to embodiments, the first element can be attached to, disposed on, or otherwise forms a part of a facial interface frame.

According to embodiments, the second element can be attached to, disposed on, or otherwise forms a part of a strap.

According to embodiments, the first coupling means comprising an interlocking engagement between the first element and the second element, and the second coupling means comprising a magnetic connection between the first element and the second element.

In some embodiments, tension applied to the strap urges the facial interface frame toward the user's head such that the facial interface conforms to contours of the user's face. Because the strap is coupled to the perimeter of the facial interface frame, forces applied by the strap may be distributed around the perimeter of the facial interface rather than being concentrated at localized regions.

This configuration provides a substantially uniform pressure distribution around the perimeter of the facial interface when the head-mounted display system is worn. The uniform pressure distribution may reduce localized pressure points and improve comfort during extended periods of use.

According to embodiments, coupling the head strap directly to the facial interface decouples strap tension from the display structure. This may reduce compressive forces applied to the user's face while maintaining secure retention of the head-mounted display system.

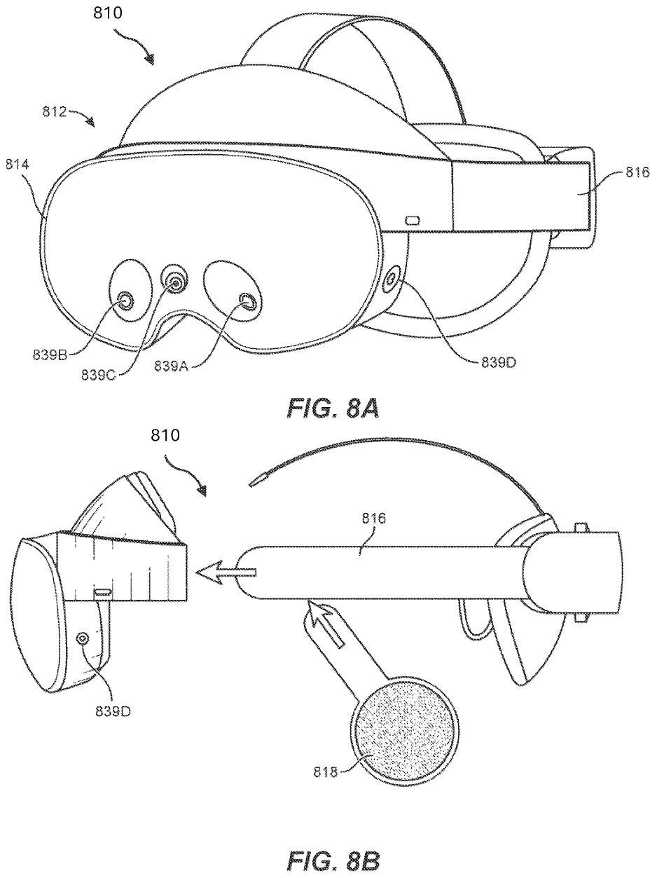

FIGS. 8A and 8B show a VR system 810 that includes a head-mounted display (HMD) 812 (for example, also referred to herein as an artificial-reality headset, a head-wearable device, a VR headset, etc.), in accordance with some embodiments. As noted, some artificial-reality systems may, instead of blending an artificial reality with actual reality, substantially replace one or more of a user's visual and/or other sensory perceptions of the real world with a virtual experience.

HMD 812 includes a front body 814 and a frame 816 (for example, a strap or band) shaped to fit around a user's head. In some embodiments, front body 814 and/or frame 816 include one or more electronic elements for facilitating presentation of and/or interactions with an AR and/or VR system (for example, displays, IMUs, tracking emitters or detectors). In some embodiments, HMD 812 includes output audio transducers (for example, an audio transducer 818), as shown in FIG. 8B. In some embodiments, one or more components, such as the output audio transducer(s) 818 and frame 816, can be configured to attach and detach (for example, are detachably attachable) to HMD 812 (for example, a portion or all of frame 816, and/or audio transducer 818), as shown in FIG. 8B. In some embodiments, coupling a detachable component to HMD 812 causes the detachable component to come into electronic communication with HMD 812.

FIGS. 8A and 8B also show that VR system 810 includes one or more cameras, such as left camera 839A and right camera 839B, which can be analogous to left and right cameras 939A and 939B on a frame of AR system 970. In some embodiments, VR system 810 includes one or more additional cameras (for example, cameras 839C and 839D), which can be configured to augment image data obtained by left and right cameras 839A and 839B by providing more information. For example, camera 839C can be used to supply color information that is not discerned by cameras 839A and 839B. In some embodiments, one or more of cameras 839A to 839D can include an optional IR cut filter configured to remove IR light from being received at the respective camera sensors.

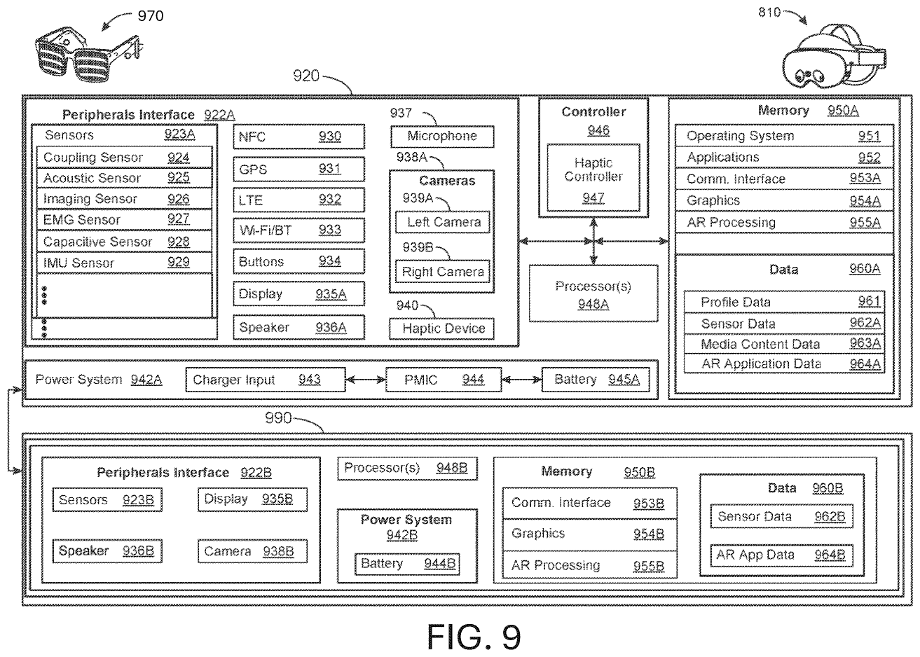

FIG. 9 illustrates a computing system 920 and an optional housing 990, each of which show components that can be included in AR system 970 and/or VR system 810. In some embodiments, more or fewer components can be included in optional housing 990 depending on practical restraints of the respective AR system being described.

In some embodiments, computing system 920 can include one or more peripherals interfaces 922A and/or optional housing 990 can include one or more peripherals interfaces 922B. Each of computing system 920 and optional housing 990 can also include one or more power systems 942A and 942B, one or more controllers 946 (including one or more haptic controllers 947), one or more processors 948A and 948B (as defined above, including any of the examples provided), and memory 950A and 950B, which can all be in electronic communication with each other. For example, the one or more processors 948A and 948B can be configured to execute instructions stored in memory 950A and 950B, which can cause a controller of one or more of controllers 946 to cause operations to be performed at one or more peripheral devices connected to peripherals interface 922A and/or 922B. In some embodiments, each operation described can be powered by electrical power provided by power system 942A and/or 942B.

In some embodiments, peripherals interface 922A can include one or more devices configured to be part of computing system 920, some of which have been defined above and/or described with respect to the wrist-wearable devices shown in FIGS. 5 and 6. For example, peripherals interface 922A can include one or more sensors 923A. Some example sensors 923A include one or more coupling sensors 924, one or more acoustic sensors 925, one or more imaging sensors 926, one or more EMG sensors 927, one or more capacitive sensors 928, one or more IMU sensors 929, and/or any other types of sensors explained above or described with respect to any other embodiments discussed herein.

In some embodiments, peripherals interfaces 922A and 922B can include one or more additional peripheral devices, including one or more NFC devices 930, one or more GPS devices 931, one or more LTE devices 932, one or more Wi-Fi and/or Bluetooth devices 933, one or more buttons 934 (for example, including buttons that are slidable or otherwise adjustable), one or more displays 935A and 935B, one or more speakers 936A and 936B, one or more microphones 937, one or more cameras 938A and 938B (for example, including the left camera 939A and/or a right camera 939B), one or more haptic devices 940, and/or any other types of peripheral devices defined above or described with respect to any other embodiments discussed herein.

AR systems can include a variety of types of visual feedback mechanisms (for example, presentation devices). For example, display devices in AR system 970 and/or VR system 810 can include one or more liquid-crystal displays (LCDs), light emitting diode (LED) displays, organic LED (OLED) displays, and/or any other suitable types of display screens. Artificial-reality systems can include a single display screen (for example, configured to be seen by both eyes), and/or can provide separate display screens for each eye, which can allow for additional flexibility for varifocal adjustments and/or for correcting a refractive error associated with a user's vision. Some embodiments of AR systems also include optical subsystems having one or more lenses (for example, conventional concave or convex lenses, Fresnel lenses, or adjustable liquid lenses) through which a user can view a display screen.

For example, respective displays 935A and 935B can be coupled to each of the lenses of AR system 970. Displays 935A and 935B may be coupled to each of lenses, which can act together or independently to present an image or series of images to a user. In some embodiments, AR system 970 includes a single display 935A or 935B (for example, a near-eye display) or more than two displays 935A and 935B. In some embodiments, a first set of one or more displays 935A and 935B can be used to present an augmented-reality environment, and a second set of one or more display devices 935A and 935B can be used to present a virtual-reality environment. In some embodiments, one or more waveguides are used in conjunction with presenting artificial-reality content to the user of AR system 970 (for example, as a means of delivering light from one or more displays 935A and 935B to the user's eyes). In some embodiments, one or more waveguides are fully or partially integrated into the eyewear device. Additionally, or alternatively to display screens, some artificial-reality systems include one or more projection systems. For example, display devices in AR system 970 and/or VR system 810 can include micro-LED projectors that project light (for example, using a waveguide) into display devices, such as clear combiner lenses that allow ambient light to pass through. The display devices can refract the projected light toward a user's pupil and can enable a user to simultaneously view both artificial-reality content and the real world. Artificial-reality systems can also be configured with any other suitable type or form of image projection system. In some embodiments, one or more waveguides are provided additionally or alternatively to the one or more display(s) 935A and 935B.

Computing system 920 and/or optional housing 990 of AR system 970 or VR system 810 can include some or all of the components of a power system 942A and 942B. Power systems 942A and 942B can include one or more charger inputs 943, one or more PMICs 944, and/or one or more batteries 945A and 944B.

Memory 950A and 950B may include instructions and data, some or all of which may be stored as non-transitory computer-readable storage media within the memories 950A and 950B. For example, memory 950A and 950B can include one or more operating systems 951, one or more applications 952, one or more communication interface applications 953A and 953B, one or more graphics applications 954A and 954B, one or more AR processing applications 955A and 955B, and/or any other types of data defined above or described with respect to any other embodiments discussed herein.

Memory 950A and 950B also include data 960A and 960B, which can be used in conjunction with one or more of the applications discussed above. Data 960A and 960B can include profile data 961, sensor data 962A and 962B, media content data 963A, AR application data 964A and 964B, and/or any other types of data defined above or described with respect to any other embodiments discussed herein.

In some embodiments, controller 946 of the eyewear device may process information generated by sensors 923A and/or 923B on the eyewear device and/or another electronic device within AR system 970. For example, controller 946 can process information from acoustic sensors 925. For each detected sound, controller 946 can perform a direction of arrival (DOA) estimation to estimate a direction from which the detected sound arrived at AR system 970. As one or more of acoustic sensors 925 detects sounds, controller 946 can populate an audio data set with the information (for example, represented in FIG. 9 as sensor data 962A and 962B).

In some embodiments, a physical electronic connector can convey information between AR system 970 and another electronic device and/or between one or more processors 948A, 948B of AR system 970 or VR system 810 and controller 946. The information can be in the form of optical data, electrical data, wireless data, or any other transmittable data form. Moving the processing of information generated by AR system 970 to an intermediary processing device can reduce weight and heat in the eyewear device, making it more comfortable and safer for a user. In some embodiments, an optional wearable accessory device (for example, an electronic neckband) is coupled to AR system 970 via one or more connectors. The connectors can be wired or wireless connectors and can include electrical and/or non-electrical (for example, structural) components. In some embodiments, AR system 970 and the wearable accessory device can operate independently without any wired or wireless connection between them.

In some situations, pairing external devices, such as an intermediary processing device with AR system 970 enables the eyewear device to achieve a similar form factor of a pair of glasses while still providing sufficient battery and computation power for expanded capabilities. Some, or all, of the battery power, computational resources, and/or additional features of AR system 970 can be provided by a paired device or shared between a paired device and eyewear device, thus reducing the weight, heat profile, and form factor of the eyewear device overall while allowing the eyewear device to retain its desired functionality. For example, the wearable accessory device can allow components that would otherwise be included on eyewear device to be included in the wearable accessory device and/or intermediary processing device, thereby shifting a weight load from the user's head and neck to one or more other portions of the user's body. In some embodiments, the intermediary processing device has a larger surface area over which to diffuse and disperse heat to the ambient environment. Thus, the intermediary processing device can allow for greater battery and computation capacity than might otherwise have been possible on the eyewear device standing alone. Because weight carried in the wearable accessory device can be less invasive to a user than weight carried in the eyewear device, a user may tolerate wearing a lighter eyewear device and carrying or wearing the paired device for greater lengths of time than the user would tolerate wearing a heavier eyewear device standing alone, thereby enabling an artificial-reality environment to be incorporated more fully into a user's day-to-day activities.

AR systems can include various types of computer vision components and subsystems. For example, AR system 970 and/or VR system 810 can include one or more optical sensors such as two-dimensional (2D) or three-dimensional (3D) cameras, time-of-flight depth sensors, structured light transmitters and detectors, single-beam or sweeping laser rangefinders, 3D LiDAR sensors, and/or any other suitable type or form of optical sensor. An AR system can process data from one or more of these sensors to identify a location of a user and/or aspects of the user's real-world physical surroundings, including the locations of real-world objects within the real-world physical surroundings. In some embodiments, the methods described herein are used to map the real world, to provide a user with context about real-world surroundings, and/or to generate digital twins (for example, interactable virtual objects), among a variety of other functions. For example, FIGS. 8A and 8B show VR system 810 having cameras 839A to 839D, which can be used to provide depth information for creating a voxel field and a two-dimensional mesh to provide object information to the user to avoid collisions.

In some embodiments, AR system 970 and/or VR system 810 can include haptic (tactile) feedback systems, which may be incorporated into headwear, gloves, body suits, handheld controllers, environmental devices (for example, chairs or floormats), and/or any other type of device or system, such as the wearable devices discussed herein. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback may be implemented using motors, piezoelectric actuators, fluidic systems, and/or a variety of other types of feedback mechanisms. The haptic feedback systems may be implemented independently of other artificial-reality devices, within other artificial-reality devices, and/or in conjunction with other artificial-reality devices.

In some embodiments of an artificial reality system, such as AR system 970 and/or VR system 810, ambient light (for example, a live feed of the surrounding environment that a user would normally see) can be passed through a display element of a respective head-wearable device presenting aspects of the AR system. In some embodiments, ambient light can be passed through a portion that is less than all of an AR environment presented within a user's field of view (for example, a portion of the AR environment co-located with a physical object in the user's real-world environment that is within a designated boundary (for example, a guardian boundary) configured to be used by the user while they are interacting with the AR environment). For example, a visual user interface element (for example, a notification user interface element) can be presented at the head-wearable device, and an amount of ambient light (for example, 15-50% of the ambient light) can be passed through the user interface element such that the user can distinguish at least a portion of the physical environment over which the user interface element is being displayed.

Embodiments of the instant disclosure may include or be implemented in conjunction with an artificial reality system. Artificial reality is a form of reality that has been adjusted in some manner before presentation to a user, which may include, for example, a virtual reality (VR), an augmented reality (AR), a mixed reality (MR), a hybrid reality, or some combination and/or derivatives thereof. Artificial reality content may include completely generated content or generated content combined with captured (for example, real-world) content. The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, for example, create content in an artificial reality and/or are otherwise used in (for example, perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

1. A facial interface assembly for a head-mounted display system, comprising:
a flexible facial interface frame element coupled to the frame element and having a perimeter configured to contact a user's face; and
an attachment mechanism comprising:
a first attachment portion positioned along at least a portion of the perimeter of the flexible facial interface frame element; and
a second attachment portion positioned along a head strap,
wherein the first attachment portion and the second attachment portion are configured to removably couple to one another and to removably couple the facial interface assembly with the head strap.

2. The facial interface assembly of claim 1, the facial interface assembly further comprising a facial ribbon disposed on an inner surface of the flexible facial interface frame element.

3. The facial interface assembly of claim 2, wherein the facial ribbon is configured to contact the user's face when the head-mounted display system is worn by the user.

4. The facial interface assembly of claim 1, wherein attachment of the attachment mechanism produces tension that urges the flexible facial interface frame element into conforming engagement with the user's face.

5. The facial interface assembly of claim 1, wherein the attachment mechanism is positioned at an outer periphery of the flexible facial interface frame element and is configured to transmit strap tension around a perimeter of the facial interface assembly.

6. The facial interface assembly of claim 1, wherein the attachment mechanism comprises an interlocking attachment structure configured to engage the head strap via a sliding motion.

7. The facial interface assembly of claim 6, wherein the interlocking attachment structure comprises complementary angled engagement surfaces configured to resist separation in a direction substantially perpendicular to the sliding motion.

8. The facial interface assembly of claim 1, wherein the attachment mechanism further comprises a first magnetic element associated with the facial interface assembly and configured to magnetically attract a corresponding second magnetic element associated with the head strap.

9. The facial interface assembly of claim 8, wherein the first magnetic element is embedded within the flexible facial interface frame element.

10. The facial interface assembly of claim 1, wherein the first magnetic element comprises a Neodymium magnet.

11. The facial interface assembly of claim 1, wherein engagement of the attachment mechanism produces uniform pressure distribution around the perimeter of the facial interface assembly.

12. The facial interface assembly of claim 1, wherein the second attachment portion is configured to slide relative to the first attachment portion during coupling.

13. The facial interface assembly of claim 1, wherein the attachment mechanism is configured to permit removal of the head strap by reversing a sliding engagement motion.

14. The facial interface assembly of claim 8, wherein the attachment mechanism is configured such that magnetic attraction between the first magnetic element and the second magnetic element provides supplemental retention relative to mechanical engagement between the first attachment portion and the second attachment portion.

15. The facial interface assembly of claim 1, wherein detachment of the attachment mechanism reduces tension applied to the flexible facial interface frame element and conformity between the facial interface assembly and the user's face.

16. The facial interface assembly of claim 1, further comprising a frame element configured to support a display of the head-mounted display system.

17. The facial interface assembly of claim 1, further comprising a nasal bridge portion.

18. The facial interface assembly of claim 17, wherein the nasal bridge portion is configured to flex in response to tension produced in response to engagement or disengagement of the attachment mechanism.

19. The facial interface assembly of claim 8, wherein engagement of the attachment structure is accomplished by sliding the second attachment portion in a direction from a front region of the facial interface toward a rear region of the facial interface.

20. The facial interface assembly of claim 1, wherein disengagement of the attachment structure is accomplished by sliding the second attachment portion in a direction from a rear region of the facial interface assembly toward a front region of the facial interface assembly.
